(19) United States
(12) Patent Application Publication
(10) Pub. No.: US 2023/0055719 A1
(43) Pub. Date: Feb. 23, 2023

(54) POWER DISTRIBUTION APPARATUS AND VEHICLE HAVING THE SAME

(71) Applicants: HYUNDAI MOTOR COMPANY, Seoul (KR); KIA CORPORATION, Seoul (KR)

(72) Inventor: Kyeongsoo SONG, Seoul (KR)

(73) Assignees: HYUNDAI MOTOR COMPANY, Seoul (KR); KIA CORPORATION, Seoul (KR)

(21) Appl. No.: 17/841,848

(22) Filed: Jun. 16, 2022

(30) Foreign Application Priority Data
Aug. 18, 2021 (KR) 10-2021-0108479

(51) Int. Cl. B60L 53/22; B60L 53/62; B60L 1/00; H02J 7/00; H02M 3/158

(52) U.S. Cl. CPC B60L 53/22; B60L 53/62; B60L 1/00; H02J 7/0048; H02M 3/1582; H02J 2310/48; B60L 2210/30

(57) ABSTRACT

A power distribution apparatus includes: a power transmitter to which a power transmission cable for supplying power to an external device is connected; a fast charger to which a fast charging cable for receiving power from a power source is connected; a processor configured to, in response to an execution command of a fast charging mode and a load power supply mode, distribute power supplied through the fast charging cable, transfer a portion of the distributed power to the external device, and transfer a remainder of the distributed power to a battery; and a power converter provided between the fast charger and the power transmitter, and configured to, when transferring the portion of the distributed power to the external device, convert a voltage of the power supplied through the fast charging cable, and transfer the voltage-converted power to the power transmitter.

### CROSS-REFERENCE TO RELATED APPLICATION

This application is based on and claims priority under 35 U.S.C. § 119 to Korean Patent Application No. 10-2021-0108479, filed on Aug. 18, 2021 in the Korean Intellectual Property Office, the disclosure of which is incorporated herein by reference.

### TECHNICAL FIELD

The present disclosure relates to a power distribution apparatus for supplying an external device with power of a battery of a vehicle and a vehicle having the same.

### BACKGROUND

A vehicle refers to a machine that travels on a road by driving vehicle wheels, and is equipped with various devices for protecting the occupant, assisting the drive, and improving the riding comfort.

The vehicle includes an internal combustion engine vehicle (a general engine driven vehicle) that generates mechanical power by burning petroleum fuels, such as gasoline and light oil and travels using the mechanical power, and an eco-friendly vehicle that travels on electricity to enhance the fuel efficiency and reduce toxic gas emissions.

Here, the eco-friendly vehicle includes: an electric vehicle that includes a battery, serving as a rechargeable power unit, and a motor such that the motor is rotated using the electricity accumulated in the battery and the vehicle wheels are driven using the rotation of the motor; a hybrid vehicle that includes an engine, a battery, and a motor and travels by controlling the mechanical power of the engine and the electric power of the motor; and a hydrogen fuel cell vehicle.

The eco-friendly vehicle is supplied with external power when a battery plug of the vehicle is connected to a wired plug of a charger disposed in a parking lot or a charging station, and uses the supplied power to charge the battery.

Recently, technologies for supplying electric power charged in a battery of an eco-friendly vehicle to an external device, that is, Vehicle to Load (V2L), have been developed. Such an eco-friendly vehicle converts power charged in the battery into power that is receivable by the external device and supplies the converted power to the external device. However, when power is converted as such, heat loss due to heat generation occurs.

### SUMMARY

Therefore, it is an object of the disclosure to provide a power distribution apparatus that, in response to a fast charging mode and a load power supply mode being selected, converts a voltage of a certain amount of power of a power source and supplies the certain amount of power to an external device and supplies the remaining amount of power of the power source to a battery, and a vehicle having the same.

The technical objectives of the disclosure are not limited to the above, and other objectives may become apparent to those of ordinary skill in the art based on the following descriptions.

According to an aspect of the disclosure, there is provided a power distribution apparatus including: a power transmitter to which a power transmission cable for supplying power to an external device is connected; a fast charger to which a fast charging cable for receiving power from a power source is connected; a processor configured to, in response to an execution command of a fast charging mode and a load power supply mode, distribute power supplied through the fast charging cable, transfer a portion of the distributed power to the external device, and transfer a remainder of the distributed power to a battery; and a power converter provided between the fast charger and the power transmitter, and configured to, when transferring the portion of the distributed power to the external device, convert a voltage of the power supplied through the fast charging cable, and transfer the voltage-converted power to the power transmitter.

The processor may be configured to: check state of charge (SOC) information of the battery; determine whether the load power supply mode is performable based on the SOC information and reference SOC information of the battery; upon determining that the load power supply mode is performable, acquire information about an amount of power to be supplied to the external device and information about an amount of power to be supplied to the battery on the basis of information about a total amount of power of the power source and information about a required amount of power of the external device; and distribute the power supplied from the power source on the basis of the acquired information about the amount of power to be supplied to the external device and the acquired information about the amount of power to be supplied to the battery.

The processor may be configured to acquire information about the amount of power to be supplied to the battery on the basis of the information about the total amount of power of the power source and the information about the required amount of power of the external device.

The processor may be configured to, upon determining that the load power supply mode is not performable, supply all of the power supplied from the power source to the battery.

The processor may be configured to, in response to execution of the fast charging mode, allow the power supplied through the fast charging cable to be transferred to the battery.

The processor may be configured to check information about a required charge amount of the battery, and control charge of the battery on the basis of the checked information about the required charge amount of the battery.

According to another aspect of the disclosure, there is provided a vehicle including: a battery; a power transmitter to which a power transmission cable for supplying power to an external device is connected; a fast charger to which a fast charging cable for receiving power from a power source is connected; an inputter configured to receive an input from a user; a processor configured to, in response to an on-command of a fast charging mode and an on-command of a load power supply mode being received through the inputter, distribute power supplied through the fast charging cable, transfer a portion of the distributed power to the external device, and transfer a remainder of the distributed power to the battery; and a power converter provided between the fast charger and the power transmitter, and configured to, when transferring the portion of the distributed power to the external device, convert a voltage of the power supplied through the fast charging cable in response to a control command of the processor and transfer the voltage-converted power to the power transmitter.

The vehicle may further include: a battery management device configured to monitor a state of charge (SOC) of the battery, and output SOC information about the monitored SOC of the battery, wherein the processor is configured to: check the SOC information of the battery; determine whether a charge amount of the battery is greater than or equal to a reference charge amount on the basis of the SOC information of the battery and reference SOC information; upon determining that the charge amount of the battery is greater than or equal to the reference charge amount, acquire information about an amount of power to be supplied to the external device and an amount of power to be supplied to the battery on the basis of information about a total amount of power of the power source and information about a required amount of the external device; and distribute the power supplied from the power source on the basis of the acquired information about the amount of power to be supplied to the external device and the amount of power to be supplied to the battery.

The processor may be configured to acquire the information about the amount of power to be supplied to the battery on the basis of the information about the total amount of power of the power source and the information about the required amount of power of the external device.

The processor may be configured to supply power to the external device on the basis of the information about the required amount of power of the external device, determine whether the supply of power to the external device is completed on the basis of the information about the required amount of power of the external device, and upon determining that the supply of power to the external device is completed, supply power to the battery.

The processor may be configured to: after completing supplying power to the external device and upon determining that the supply of power to the battery is not completed on the basis of the information about the amount of power to be supplied to the batter, continue to supply the power to the battery.

The processor may be configured to: after completing supplying power to the external device and upon determining that the supply of power to the battery is completed on the basis of the information about the amount of power to be supplied to the batter, stop supplying the power to the battery.

The processor may be configured to, upon determining that the charge amount of the battery is less than the reference charge amount, supply all of the power supplied from the power source to the battery.

The vehicle may further include a display, wherein the processor may be configured to control the display to display information indicating that the load power supply mode is not performable upon determining that the charge amount of the battery is less than the reference charge amount.

The processor may be configured to, in response to execution of the fast charging mode, allow the power supplied through the fast charging cable to be transferred to the battery.

The processor may be configured to check information about a required charge amount of the battery, and control charge of the battery on the basis of the checked information about the required charge amount of the battery.

The vehicle may further include a slow charger to which a slow charging cable to receive power from the power source is connected, wherein the processor may be configured to, in response to an on-command of a slow charging mode being received through the inputter, control the power converter to convert a voltage of power supplied through the slow charging cable, and the power converter may be configured to convert the voltage of the power supplied through the slow charging cable in response to a control command of the processor, and transfer the converted power to the battery.

The processor may be configured to perform the slow charging mode on the basis of a connection signal of the slow charging cable.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is an exemplary diagram illustrating a vehicle according to an embodiment;

FIG. 2 is a control block diagram illustrating the vehicle according to the embodiment;

FIG. 3 is a detailed block diagram illustrating a battery management device provided in the vehicle according to the embodiment;

FIG. 4 is an exemplary diagram illustrating a flow of power for each mode of the vehicle according to the embodiment;

FIG. 5 is a detailed block diagram of a power converter provided in the vehicle according to the embodiment; and

FIG. 6 is a control flowchart of the vehicle according to an embodiment.

### DETAILED DESCRIPTION

Like numerals refer to like elements throughout the specification. Not all elements of embodiments of the present disclosure will be described, and description of what are commonly known in the art or what overlap each other in the embodiments will be omitted. The terms as used throughout the specification, such as part“, module”, member“, block”, etc., may be implemented in software and/or hardware, and a plurality of parts“, modules”, members“, or blocks” may be implemented in a single element, or a single part“, module”, member“, or block” may include a plurality of elements.

It will be further understood that the term “connect” or its derivatives refer both to direct and indirect connection, and the indirect connection includes a connection over a wireless communication network.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless the context clearly indicates otherwise.

Although the terms “first,” “second,” “A,” “B,” etc. may be used to describe various components, the terms do not limit the corresponding components, but are used only for the purpose of distinguishing one component from another component.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

Hereinafter, the operating principles and embodiments of the present disclosure will be described with reference to the accompanying drawings.

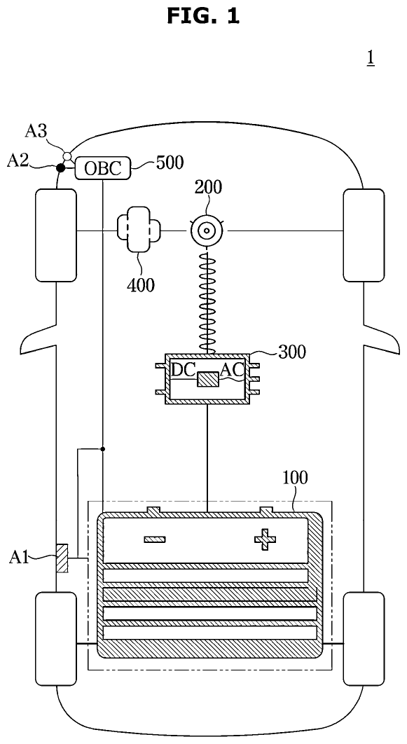

FIG. 1 is an exemplary diagram illustrating a vehicle 1 according to an embodiment.

The vehicle according to the embodiment is an eco-friendly vehicle that runs using a battery and a motor, and may include an electric vehicle or a plug-in hybrid electric vehicle (PHEV). In the embodiment, an electric vehicle will be described as an example.

The vehicle 1 includes a body having an interior and an exterior, and a chassis, which is a part of the vehicle 1 except for the body, in which mechanical devices required for traveling are installed.

The exterior of the body includes a front panel, a bonnet, a roof panel, a rear panel, front and rear, left and right doors, and window glasses provided on the front and rear, left and right doors to be openable and closable.

The exterior of the body includes pillars provided at the boundaries between the window glasses of the front, rear, left, and right doors, a side mirror that provides the driver with a rear view of the vehicle 1, and an external lamp that allows the driver to easily view information about a surrounding while looking to the front, and perform signaling to other vehicles and pedestrians, and communication with vehicles and pedestrians.

The chassis of the vehicle 1 is a frame that supports the body, and the chassis may be provided with wheels disposed at the front, rear, left and right side thereof, a power device for applying a driving force to the front, rear, left, and right vehicle wheels, a steering device, a braking device for applying a braking force to the front, rear, left, and right vehicle wheels, and a suspension device.

The power device may include a power generation device and a power transmission device.

In the case of an electric vehicle, the power generation device may include a battery and a motor.

In the case of a plug-in hybrid vehicle, the power generation device may include a battery, a motor, an engine, a fuel device, a cooling device, and a fuel supply device.

Referring to FIG. 1, the power device of the vehicle 1 includes a battery 100, a motor 200, a motor driver 300, a reducer 400, and a power converter 500.

The battery 100 may include a plurality of battery cells that generate a high-voltage current to supply the vehicle 1 with driving power.

The battery 100 may include a plurality of battery modules, and each of the battery modules may include a plurality of battery cells connected in series and in parallel.

The battery cells may form a battery module together with each other, and battery modules may form a battery pack together with each other.

The motor 200 generates a rotational force using the electrical energy of the battery 100 and transmits the generated rotational force to the vehicle wheels to drive the wheels.

The motor 200 converts electrical energy of the battery 100 into mechanical energy for operating various devices provided in the vehicle 1.

The motor 200, in response to a booting button being turned on, is supplied with a maximum current to generate a maximum torque.

The motor 200 may operate as a generator under energy regeneration conditions by braking, deceleration, downhill driving, or low-speed driving, so that the battery 100 is charged.

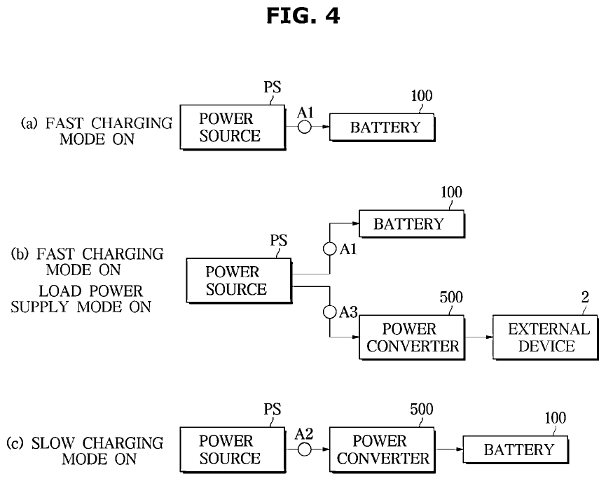

The motor driver 300 drives the motor 200 in response to a control command of a first processor. The motor driver 300 may include an inverter (300a in FIG. 4) that converts power of a battery into driving power of the motor 200.

The inverter is configured to, in the output of driving power of the motor 200, output driving power of the motor 200 on the basis of a target vehicle speed according to a user command. Here, the driving power of the motor 200 may vary according to a switching signal for outputting a current corresponding to the target vehicle speed and a switching signal for outputting a voltage corresponding to the target vehicle speed.

The inverter may also transfer power generated from the motor 200 to the battery 100 during regenerative braking. That is, the inverter may include a plurality of switch elements, and perform a function of changing the direction and output of the current between the motor 200 and the battery 100.

The reducer 400 transmits, to the vehicle wheels, a rotational force obtained by decelerating the speed of the motor 200 and increasing the torque of the motor 200.

The vehicle 1 may further include a charger provided on the exterior of the body, connected with a fast charging cable or a slow charging cable, and receiving power for charging the battery 100.

The charger may include a fast charger A1 for rapidly charging the battery 100 and a slow charger A2 for charging the battery 100 at a rate that is lower than that of the fast charging.

The fast charger A1 may be connected with the fast charging cable for fast charging, and the slow charger A2 may be connected with the slow charging cable for slow charging.

In addition, the fast charger A1 for fast charging and the slow charger A2 for slow charging, which has a charging rate lower than that of fast charging, may be provided at the same position on the exterior of the vehicle 1 or may be provided at different positions on the exterior of the vehicle 1.

The fast charger A1 and the slow charger A2 may represent outlets to which the fast charging cable for charging and the slow charging cable for charging are connected.

The fast charger A1 may allow an external power source connected to the fast charging cable to be directly connected to the battery 100 of the vehicle. Here, the external power source may be power from a charging station or a power grid, and supply the vehicle 1 with power of approximately 220V voltage.

In addition, the fast charging cable may be provided inside thereof with a converter including a converter, an inverter, a high frequency isolation transformer, a rectifier, etc. The converter in the fast charging cable may convert commercial alternating current (AC) power into power for fast charging the battery of the vehicle 1.

In addition, the power source may include a fast power source and a slow power source.

The fast power source may supply power of approximately 800V voltage to the vehicle 1 through the fast charging cable. In this case, the fast charging cable may be used as a device for supplying power of 800V voltage.

The slow power source may supply power of 220V voltage to the vehicle 1.

The slow charger A2 may be an outlet into which a 5-pin connector is inserted and connected, or an outlet into which a 7-pin connector is inserted and connected.

When the cable is a 5-pin connector, the cable may include a live pin L1, a neutral pin L2/N, a ground pin GND, a proximity detection pin PD, and a Control Pilot pin CP, which is a control confirmation pin.

When the cable has 7 pins, the cable is a 3-phase AC connector and may further include L2 and L3 pins.

The vehicle 1 further includes a power converter 500 (On Board Charge: OBC) that is connected to the slow charger A2 and converts the external commercial power (AC power) supplied from the slow charger A2 into rectified and direct current that is then transmitted to the battery 100. For example, the power converter 500 may include an AC rectifier, a power factor correction (PFC), a converter, and a capacitor.

The power converter 500 may be provided with a power transmitter A3 to which a power transmission cable is connected.

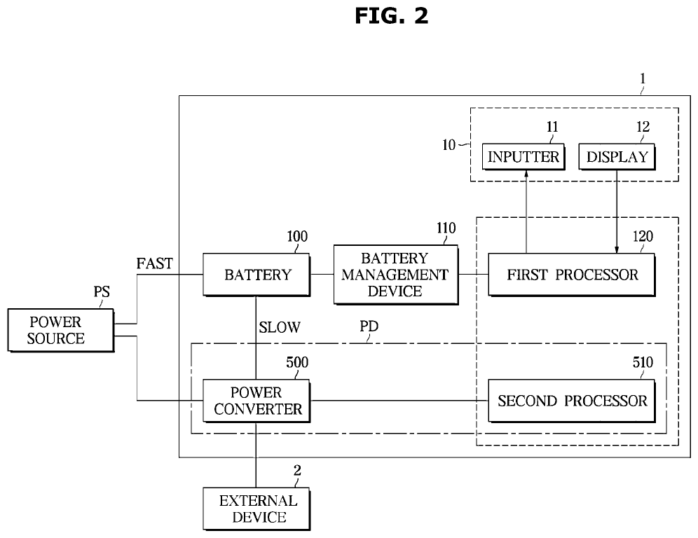

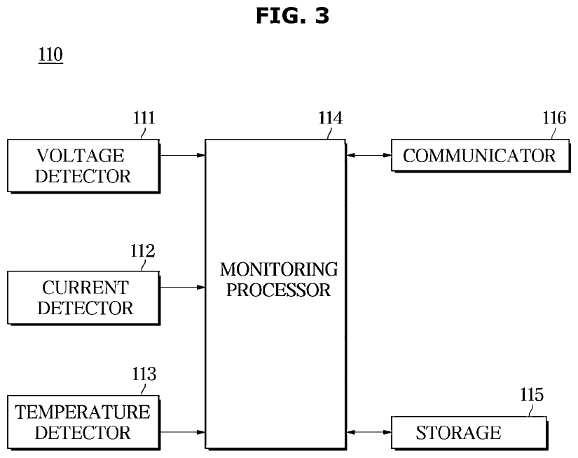

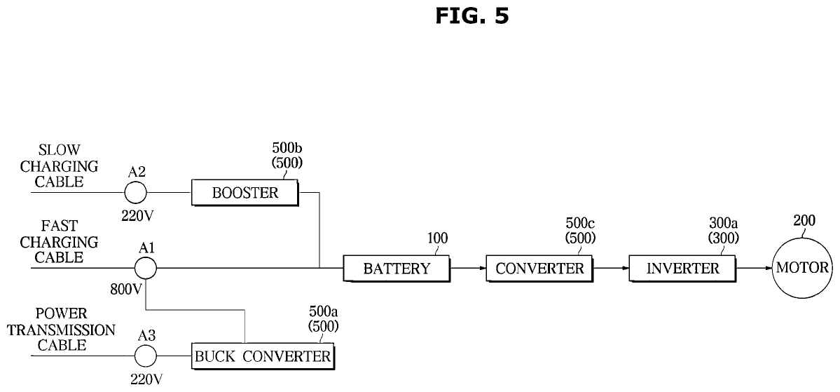

FIG. 2 is a control block diagram illustrating the vehicle according to the embodiment, FIG. 3 is a detailed block diagram illustrating a battery management device provided in the vehicle according to the embodiment, FIG. 4 is an exemplary diagram illustrating a flow of power for each mode of the vehicle according to the embodiment, and FIG. 5 is a detailed block diagram of a power converter provided in the vehicle according to the embodiment.

The vehicle 1 includes a user interface 10, a battery 100, a battery management device 110, a first processor 120, a power converter 500, and a second processor 510.

The user interface 10 receives a user input and displays various pieces of information about functions performed in the vehicle 1.

The user interface 10 may include an inputter 11 and a display 12.

The inputter 11 receives an on/off command for at least one function among a plurality of functions, and an operation command for the input at least one function.

The inputter 11 may receive a communication-on command and a communication-off command with a server (not shown).

The inputter 11 may receive an on/off command of a fast charging mode and an on/off command of a slow charging mode, and may also receive an on/off command of a load power supply mode.

The inputter 11 may also receive information about payment of a power rate for battery charging or load power supply.

The inputter 11 may receive reservation mode and reservation time information, and may also receive a command to display hourly power rate information.

The display 12 displays operation information regarding a function being performed.

The display 12 may display on/off information of the fast charging mode, on/off information of the slow charging mode, and on/off of the load power supply mode.

The display 12 may display reservation information. Here, the reservation information may include information about a reservation time and information about a required amount of charge of the battery. The reservation information may include, as information regarding a mode to be performed at the reservation time, on/off information of the fast charging mode, on/off information of the slow charging mode, and on/off information of the load power supply mode, and may include information about a required amount of power corresponding to the on-information of the load power supply mode.

The display 12 may display hourly power rate information when the power rate of power supplied from the power source (PS) varies with the time of supplying power.

The display 12 may also display information about the required amount of power of the load corresponding to the on-information of the load power supply mode, and may display information about power usage fees about the power supplied to the battery 100 and the power supplied to the load.

The display 12 may display information about a time required for charging the battery 100 and information about a time required for supplying power to a load (i.e., an external device).

The display 12 may display a state of charge (SOC) information of the battery 100 and may also display power supply state information of the load.

The SOC information of the battery 100 may include a charge amount of the battery 100 and a charge level corresponding to the charge amount of the battery 100.

The vehicle 1 may further include a sound outputter (not shown) for outputting various types of information about a start of charging of the battery, a completion of charging of the battery, a start of supply of power to the external device, and a completion of supply of power to the external device as sound.

The sound outputter may include one or two or more speakers.

The battery 100 may be a battery capable of being charged and discharged.

The battery 100 may supply driving power to the power device including the motor 200. Such a battery is also referred to as a main battery.

The battery 100 may be charged using power supplied from the power source (PS).

The battery 100 may be charged using the power generated by the generator driven based on regenerative braking during a travel.

The battery 100 may perform a slow charging mode or a fast charging mode in response to a cable connected to the charger.

The battery 100 may supply power for operation to electronic devices, such as convenience devices and additional devices. For this, the vehicle 1 may further include an auxiliary battery.

Here, the output voltage of the main battery may be the same as the output voltage of the auxiliary battery or may be higher than the output voltage of the auxiliary battery.

When the auxiliary battery is provided in the vehicle 1, the auxiliary battery may be charged using power charged in the main battery.

The battery management device 110 monitors a state of charge, a state of discharge, and a state of failure of the battery 100.

The battery management device 110 may monitor the state of each battery cell in units of battery cells, and may monitor the state of each battery module in units of battery modules, and monitor the state of the battery pack.

The battery management device 110 includes a voltage detector 111, a current detector 112, and a temperature detector 113, as a detector that detects the SOC of the battery 100 to monitor the state of the battery 100.

The battery management device 110 may further include a monitoring processor 114, a storage 115, and a communicator 116.

The voltage detector 111 and the current detector 112 may be detectors that detect electrical signals for each cell of the battery 100.

The voltage detector 111 detects a voltage of the battery 100 and outputs a voltage signal corresponding to the detected voltage.

The voltage detector 111 may be provided in plural.

The plurality of voltage detectors 111 may be connected to output terminals of the plurality of battery cells, respectively, to detect respective voltages of the plurality of battery cells.

The plurality of voltage detectors 111 may be connected to output terminals of the plurality of battery modules, respectively, to detect respective voltages of the plurality of battery modules.

The voltage detector 111 may be connected to an output terminal of the battery pack to detect the voltage of the battery pack.

The current detector 112 detects a current of the battery 100 and outputs a current signal corresponding to the detected current.

The current detector 112 may be provided in plural.

The plurality of current detectors 112 may detect currents flowing through the plurality of battery cells, respectively.

The plurality of current detectors 112 may detect currents flowing through the plurality of battery modules, respectively.

The current detector 112 may detect a current flowing through the battery pack. Here, the battery pack may refer to a battery in the embodiment.

The temperature detector 113 detects the temperature of the battery 100 and outputs a temperature signal corresponding to the detected temperature. The temperature detector 113 may be provided inside the battery pack.

The temperature detector 113 may be provided in plural.

The plurality of temperature detectors 113 may be provided in the plurality of battery cells, respectively, and may detect temperatures of the plurality of battery cells, respectively.

The plurality of temperature detectors 113 may be provided in the plurality of battery modules, respectively, and may detect temperatures of the plurality of battery modules, respectively.

The temperature detector 113 may be provided in the battery pack, and may detect the temperature of the battery pack.

The monitoring processor 114 monitors the SOC of the battery 100 based on the detected current of the battery 100.

The monitoring processor 114 may monitor the SOC of the battery 100 based on the detected current and voltage of the battery 100.

The monitoring processor 114 may monitor the SOC of the battery 100 based on the current, voltage, and temperature of each of the battery cells of the battery 100.

Here, the SOC of the battery 100 may include a charge amount of the battery 100.

That is, the monitoring processor 114 may acquire the SOC of the battery corresponding to the current, voltage, and temperature of the battery 100 from a table stored in advance. In the pre-stored table, the charge amount of the battery having a correlation with the current, voltage, and temperature of the battery may be matched.

The monitoring processor 114 may be configured to, upon a boot-on command being received from the first processor 120, check the SOC of the battery 100, and transmit SOC information of the checked SOC of the battery to the first processor 120.

The monitoring processor 114 may determine thermal runaway based on temperature information detected by the temperature detector 113.

The monitoring processor 114 may be configured to, upon determining that the battery 100 is in a thermal runaway state, control the driving of a fan (not shown) such that the fan rotates at the maximum rotation speed. With such a configuration, gas generated from the battery 100 may be discharged to the outside.

The monitoring processor 114 may include a memory (not shown) for storing data regarding an algorithm for controlling the operations of the components of the battery management device 110 or a program that represents the algorithm, and a processor (not shown) that performs the above described operations using the data stored in the memory. In this case, the memory and the processor may be implemented as separate chips. Alternatively, the memory and the processor may be implemented as a single chip.

The storage 115 may store a table in which the SOC of the battery 100 having a correlation with the current, voltage, and temperature of the battery 100 is matched.

The storage 115 may store a table in which the charge amount of the battery 100 having a correlation with the current, the voltage, and the temperature of the battery 100 is matched.

The storage 115 may store reference SOC information for determining whether to perform the load power supply mode. The reference SOC information may include a reference charge amount and a reference SOC.

The storage 115 may include a nonvolatile memory device, such as a cache, a read only memory (ROM), a programmable ROM (PROM), an erasable programmable ROM (EPROM), an electrically erasable programmable ROM (EEPROM), and a flash memory, a volatile memory device, such as a random access memory (RAM), or other storage media, such as a hard disk drive (HDD), a CD-ROM, and the like, but the implementation of the storage 115 is not limited thereto.

The communicator 116 performs communication between the first processor 120 and the monitoring processor 114, and transmits SOC information of the battery 100 to the first processor 120.

The communicator 116 may include one or more components that enable communication with the monitoring processor 114 and the first processor 120, for example, at least one of a short-range communication module, a wired communication module, and a wireless communication module.

The short-range communication module may include various short-range communication modules that may transmit and receive signals in a short distance using a wireless communication network, for example, a Bluetooth module, an infrared communication module, a radio frequency identification (RFID) communication module, a wireless local access network (WLAN) communication module, a near field communication (NFC) communication module, a Zigbee communication module, and the like.

The wired communication module may include not only various wired communication modules, such as a controller area network (CAN) communication module, a local area network (LAN) communication module, a wide area network (WAN) module, or a value added network (VAN) module, but also various cable communication modules, such as a universal serial bus (USB), a high definition multimedia interface (HDMI), a digital visual interface (DVI), a recommended standard 232 (RS-232), power line communication, or plain old telephone service (POTS).

The wireless communication module may include various wireless communication modules for supporting various wireless communication methods, such as a Wifi module, a wireless broadband (Wibro) module, a global system for mobile communication (GSM), a code division multiple access (CDMA), a wideband code division multiple access (WCDMA), universal mobile telecommunications system (UMTS), a time division multiple access (TDMA), a long term evolution (LTE), and the like.

The first processor 120 may control the operation of the display 12 such that the SOC information of the battery 100 transmitted from the battery management device 110 is output on the display 12, and control the operation of the sound outputter (not shown) such that the SOC information of the battery 100 is output on the sound outputter (not shown).

The first processor 120 receives the SOC information about the SOC of the battery 100 from the battery management device 110, determines whether charging of the battery 100 is required based on the SOC information, and upon determining that charging of the battery 100 is required, controls the display 12 to output information indicating a need to charge the battery 100. Here, the SOC information of the battery 100 may include the charge amount of the battery 100.

The first processor 120 may be configured to, upon a charging command of the battery 100 being received through the inputter 11, control the display 12 to display SOC information about the current SOC of the battery 100, and acquire a required charge amount on the basis of the SOC information, and control the display 12 to display information about the acquired required charge amount.

The first processor 120 may be configured to, upon determining that the charging command is a fast charging command, acquire time information and power usage fee information required for fast charging on the basis of the current SOC information of the battery 100, and control the display 12 to the acquired time information and power usage fee information required for fast charging.

The first processor 120 may be configured to, upon determining that the charging command is a slow charging command, acquire time information and power usage fee information required for slow charging on the basis of the current SOC information of the battery 100, and control the display 12 to the acquired time information and power usage fee information required for slow charging.

The first processor 120 may be configured to, upon receiving an on-command of the load power supply mode during execution of the fast charging mode, transmit a load power supply command mode to the second processor 510.

The first processor 120 may be configured to, upon receiving information about a required amount of power together with the on-command of the load power supply mode during execution of the fast charging mode, transmit the received information about the required amount of power to the second processor 510.

The first processor 120 may acquire time information required for the fast charging and the supply of the load power and the power usage fee information on the basis of the current SOC information of the battery 100 and the information about the required amount of power, and control the display 12 to display the acquired time information and the power usage fee information.

The first processor 120 may be configured to, upon receiving information about the required amount of power together with the on-command of the load power supply mode during execution of the fast charging mode, determine whether the load power supply mode is performable on the basis of the current SOC information of the battery 100, and upon determining that the load power supply mode is not performable, control the display 12 to display load power supply mode unavailability information indicating an unavailability to perform the load power supply mode, and upon determining that the load power supply mode is performable, control the display 12 to display information indicating the availability to perform the load power supply mode.

The first processor 120 may control the display 12 to display hourly power rate information received from a server (not shown) in response to a user input received through the inputter 11.

When the hourly power rate information varies, the first processor 120 may acquire the hourly power usage fee information and control the display 12 to display the acquired hourly power usage fee information.

The first processor 120 may be configured to, upon receiving an on-command of a reservation mode and reservation time information through the inputter 11, determine whether the current time is the reservation time based on the received reservation time information and the current time information, and upon determining the current time is the reservation time, control execution of the slow charging mode or the fast charging mode in response to the slow charging mode or the fast charging mode input by the user.

Referring to drawing (a) of FIG. 4, the first processor 120 may be configured to, in response to execution of the fast charging mode, determine whether the fast charging cable is connected to the fast charger A1, and upon determining that the fast charging cable is connected to the fast charger A1, allow the battery 100 to be charged using the power received from the power source PS.

In this case, the power of the power source PS may be directly supplied to the battery 100 through the fast charging cable connected to the fast charger A1.

Referring to drawing (b) of FIG. 4, the first processor 120 may be configured to, upon receiving an on-command of the load power supply mode and information about a required amount of power during execution of the fast charging mode, determine whether the power transmitter A3 is connected to the power transmission cable, and upon determining that the power transmitter A3 is connected to the power transmission cable, transmit a load power supply command to the second processor 510, and when the supply of power to the external device 2 is completed, allow the battery 100 to be charged using power received from the power source PS.

In this case, the second processor 510 may control the power converter 500 to convert the voltage of power supplied from the power source, and transmit the voltage-converted power to the external device through a power transmission terminal and a power transmission cable.

Referring to drawing (c) of FIG. 4, the first processor 120 may be configured to, in response to execution of the slow charging mode, determine whether the slow charging cable is connected to the slow charger A2, and upon determining that the slow charging cable is connected to the slow charger A2, control the power converter 500 to convert the voltage of the power received from the power source PS, and allow the battery 100 to be charged using the voltage-converted power.

The first processor 120 may determine whether the slow charging cable is connected to the slow charger A2 based on a signal of the proximity detector pin of the slow charging cable.

The first processor 120 may control the inverter to drive the motor 200 so that traveling is performed.

The first processor 120 may be configured to, upon determining that a power transmission cable is connected to the power transmitter A3 of the vehicle 1 while the fast charging cable is connected to the fast charger A1, transmit, to the second processor 510, a power supply command for supplying power to the external device 2.

The first processor 130 may be configured to, upon receiving an on-command of the fast charging mode and an on-command of the load power supply mode through the inputter 11, transmit, to the second processor 510, a power supply command for supplying power to the external device 2.

The first processor 120 may be configured to, upon information about a required amount of power to be supplied to the external device 2 being received through the inputter 11, transmit the received information about the required amount of power to the second processor 510.

The first processor 120 may include a memory (not shown) for storing data regarding an algorithm for controlling the operations of the components of the vehicle 1 or a program that represents the algorithm, and a processor (not shown) that performs the above-described operations using the data stored in the memory. In this case, the memory and the processor may be implemented as separate chips. Alternatively, the memory and the processor may be implemented as a single chip.

A power distribution apparatus PD may be configured to, upon receiving a load power supply command from the first processor 130, determine whether supply of power to the external device 2, which is a load, is performable on the basis of the current SOC information of the battery 100 and the reference SOC information, and upon determining that supply of power to the external device 2 is performable, distribute power supplied from the power source PS for the external device 2 and the battery 100 of the vehicle are supplied with power.

The power distribution apparatus PD may be configured to, upon receiving the required power amount information of the external device 2, acquire information about the amount of power to be supplied to the battery 100 based on the received required power amount information and information about the amount of power supplied from the power source PS.

The power distribution apparatus PD may be configured to, upon determining that supply to the external device 2 is not performable, allow all of the power supplied from the power source PS to be supplied to the battery 100 of the vehicle 1.

The power distribution apparatus PD may include the power converter 500 and the second processor 510.

The power converter 500 converts the voltage of power received through the fast charging cable and the fast charger A1 in response to execution of the load power supply mode, and transmits the voltage-converted power to the external device 2 through the power transmitter A3 and the power transmission cable.

Referring to FIG. 5, the power converter 500 may include a buck converter 500a for stepping down the voltage of the power received through the fast charging cable and the fast charger A1.

More specifically, in the fast charging cable, a converter including a converter, an inverter, a high frequency isolation transformer, a rectifier, etc. may be provided.

The converter in the fast charging cable may convert commercial AC power into power for fast-charging the battery 100 of the vehicle 1. That is, when performing the fast charging mode and the load power supply mode, the voltage of the power received by the fast charger A1 through the fast charging cable is approximately 800V.

In addition, when the power source is a fast speed power source, the fast charging cable may receive power of about 800 V from the fast speed power source and transmit the received power of about 800 V to the fast charger A1.

Accordingly, the power converter 500 converts the voltage (approximately 800V) of the power received through the fast charging cable and the fast charger A1 to power of approximately 220V through the buck converter 500a, and supplies the power, of which the voltage is converted to 220V, to the external device 2.

The power converter 500, in response to execution of the slow charging mode, converts power supplied from the power source PS into power for charging the battery 100, and supplies the converted power to the battery 100.

The power converter 500 may include a booster 500b and further include a filter (not shown) provided between the power source PS and the booster 500b to remove noise between the external AC power and the battery 100.

The booster 500b may be configured to, upon receiving AC power of the power source PS, rectify the received AC power and boost the rectified DC power to DC power suitable for charging the battery 100, and supply the boosted DC power to the battery 100 so that the battery 100 may be charged.

The booster 500b may include at least one switch element and an inductor.

More specifically, during an on-time of the switch element of the booster 500b, the current of AC power is converted into DC power through a rectifier (not shown), and the converted DC power current flows through the inductor, so that energy is stored to the inductor. In this case, the inductor stores energy in the form of a magnetic field.

During an off-time of the switch element of the booster 500b, the energy stored in the inductor is released. In this case, the emitted energy is provided as an electromotive force having a polarity opposite to the direction of the current flowing during the on-time of the switch element.

The electromotive force is generated in the direction of continuously maintaining the current flowing during the on-time of the switch element. The voltage generated as such is referred to a counter electromotive force, and is used to boost a voltage. Then, the boosted voltage is rectified by a diode (not shown) and then applied to the battery 100. With such a configuration, the battery 100 may be charged.

The power converter may further include a converter 500c that boosts the DC power of the battery 100 to increase the output and efficiency of the motor 200.

The converter 500c converts the DC power charged in the battery 100 into DC power greater than or equal to a predetermined magnitude.

The slow charging mode may be described as an example of charging. When an AC voltage of approximately 220V is converted to a DC voltage of 600V to 750V using a booster and charged in the battery 100, the converter 500c may convert the DC voltage of approximately 600V (standard type) to 750V (constant type) output from the battery 100 into a DC voltage of approximately 300V. Here, the converter 500c may be omitted depending on the output of the battery 100, the driving power of the motor 200, and the capability of the inverter 300a.

In addition, the inverter 300a of the motor driver 300 converts a DC voltage into an AC voltage in response to the output voltage received from the converter 500c and applies the converted AC voltage to the motor 200.

The inverter 300a transfers regenerative energy of the motor 200 to the battery 100 during braking of the vehicle 1 so that the battery 100 is charged.

The second processor 510 may be configured to, upon an on-command of the load power supply mode and a required amount of power being received from the first processor 120, check the SOC information of the battery 100, and determine whether the charge amount of the battery 100 is greater than or equal to a reference charge amount on the basis of the checked SOC information of the battery 100 and the reference SOC information. The reference SOC information may be information indicating about a SOC of 30%.

The second processor 510 may be configured to, upon determining that the charge amount of the battery 100 is less than the reference charge amount, control termination of the load power supply mode and transmit load power supply unavailability information to the first processor 120.

The second processor 510 may be configured to, upon determining that the charge amount of the battery 100 is greater than or equal to the reference charge amount, check the total amount of power supplied from the power source PS and check the required amount of power of the external device 2 transmitted from the first processor 120, and allow the battery 100 to be supplied with an amount of power corresponding to a value of the total amount of power of the power source PS minus the required amount of power of the external device 2.

The second processor 510 may transmit load power supply availability information to the first processor 120.

The second processor 510 may be configured to supply the external device 2 with power, of which the voltage is converted through the power converter 500, and check the amount of power supplied to the external device 2 during supply of power to the external device 2, and upon determining that the checked amount of power is equal to the required amount of power of the external device 2, terminate supply of the power to the external device 2 and allow power to be directly supplied to the battery 100 through the fast charging cable and the fast charger A1.

The power distribution configuration of the second processor 510 is expressed as an equation below.

The required amount of power for the external device=a [kW]

The required charge amount of the battery=b [kW]

The actual amount of power supplied to the external device=c [kW]

The actual amount of charge of the battery=d [kW]

If the current SOC of the battery >=30%, c=a [kW], and d=b−c [kW]

If the current SOC of the battery <30%, c=0 [kW], d=b [kW]

Although the embodiment has been described as controlling the operation of the power converter by the second processor in response to the load power supply mode, the operation of the power converter may also be controllable by the first processor.

In addition, the first processor and the second processor may be implemented as one processor.

At least one component may be added or omitted to correspond to the performance of the components of the vehicle shown in FIGS. 2 and 5. In addition, the mutual positions of the components may be changed to correspond to the performance or structure of the system.

The components shown in FIG. 2 may refer to a software component and/or a hardware component, such as a Field Programmable Gate Array (FPGA) and an Application Specific Integrated Circuit (ASIC).

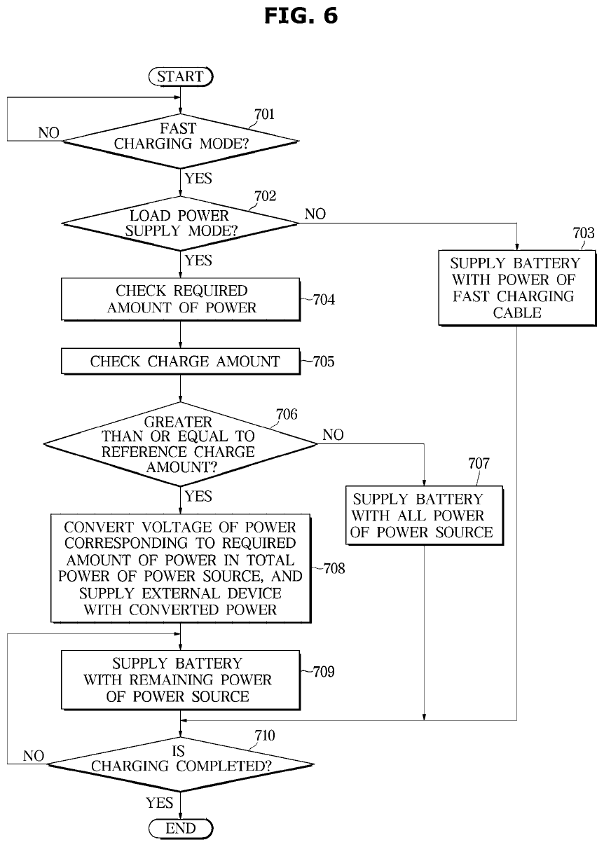

FIG. 6 is a control flowchart of the vehicle according to an embodiment.

The vehicle determines whether an on-command of the fast charging mode is received through the inputter 11 (701).

In addition, the vehicle determines whether the fast charging cable is connected to the fast charger A1, and, upon determining that the fast charging cable is connected to the fast charger A1, determine that an on-command of the fast charging mode is received.

The vehicle, upon determining that an on-command of the fast charging mode is received, determines whether an on-command of the load power supply mode and information about a required amount of power are received through the inputter 11 (702).

In addition, the vehicle may be configured to, upon determining that the power transmission cable is connected to the transmitter A3 of the vehicle while the fast charging cable is connected to the fast charger A1, determine that an on-command of the load power supply mode is received.

The vehicle may, upon determining that an off-command of the load power supply mode is received and only an on-command of the fast charging mode is received, charge the battery 100 through the fast charging mode.

The vehicle may, upon determining that an on-command of the load power supply mode is not received and only an on-command of the fast charging mode is received, charge the battery through the fast charging mode.

The vehicle may be configured to, when charging the battery through the fast charging mode, charge the battery with a voltage (approximately 800V) of the power received through the fast charging cable and the fast charger A1 (703).

The vehicle, upon determining that the fast charging mode and the load power supply mode need to be simultaneously performed, checks the required amount of power of the external device that is received through the inputter (704).

Next, the vehicle determines whether supply of power to the external device 2 serving as a load is performable on the basis of the current SOC information of the battery and the reference SOC information. That is, the vehicle checks the SOC information of the battery (705), determines whether the charge amount of the battery is greater than or equal to the reference charge amount on the basis of the checked SOC information of the battery and the reference SCO information (706), and upon determining that the charge amount of the battery is less than the reference charge amount, determines that supply of power to the external device 2 is not performable, and terminates the load power supply mode, and supplies all of the power supplied from the power source to the battery (707). In this case, the vehicle may perform the fast charging mode, and charge the battery using the power received through the fast charging cable and the fast charger A1 by the fast charging mode. The vehicle may display load power supply unavailability information through the display.

The vehicle, upon determining that the charge amount of the battery is greater than or equal to the reference charge amount, determines that supply of power to the external device 2 is performable, checks the total amount of power supplied from the power source (PS) and substrates the required amount of power of the external device from the checked total amount of power to acquire an amount of power to be supplied to the battery.

The vehicle may also display information about the total amount of power of the power source, the required amount of power of the external device, and the amount of power to be supplied to the battery through the display.

The vehicle supplies power to the external device and the battery on the basis of the total amount of power of the power source, the required amount of power of the external device, and the amount of power to be supplied to the battery.

More specifically, the vehicle supplies the external device with an amount of power corresponding to the required amount of power in the total amount of power of the power source, by converting the voltage of the power supplied from the power source through the charging cable, and supplying the external device with the voltage-converted power through the power transmitter A3 and the power transmission cable (708).

The charging cable may boost the voltage of power supplied from the power source and supply the boosted power to the battery. The voltage of the power supplied from the power source may be approximately 220V, and the voltage of the boosted power may be approximately 800V.

Next, the vehicle compares the amount of power supplied to the external device with the required amount of power of the external device, and upon determining that the amount of power supplied is equal to the required amount of power, terminates the load power supply mode and performs a fast charging mode to charge the battery.

That is, the vehicle supplies the battery with the remaining amount of power excluding the required amount of power of the external device from the total amount of power of the power source (709).

The vehicle determines whether the charging of the battery is complete on the basis of the amount of power supplied to the battery and the remaining amount of power (710), and upon determined that the charging of the battery is completed, terminates the fast charging mode.

The vehicle may display termination information of the load power supply mode and the fast charging mode through the display, and may display power usage fee information.

The voltage of the battery is approximately 600V (standard type) or 750V (constant type), and the voltage of the power supplied through the charging cable is approximately 800V.

The amount of heat generated when the voltage of the power supplied through the charging cable is converted into a voltage (220V) usable by the external device is smaller than the amount of heat generated when the voltage of the power charged in the battery is converted into a voltage (220V) usable by the external device.

That is, power P is the product of voltage V and current I (P=V*I), and the amount of heat generation is proportional to the square of current (the amount of heat generation=current²*resistance*time). Accordingly, it can be seen that when the current decreases, the amount of heat generated decreases. It can also be seen that the voltage needs to be high for the current to decrease.

The present disclosure may reduce the amount of heat generation when power of a power source is supplied to an external device through a fast charging cable during fast charging, by stepping down the voltage of the power through a power converter, and supplying the power to the external device, and accordingly, improve heat loss.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a non-transitory computer-readable recording medium.

The computer-readable recording medium includes all kinds of recording media in which instructions which may be decoded by a computer are stored, for example, a Read only Memory (ROM), a Random-Access Memory (RAM), a magnetic tape, a magnetic disk, a flash memory, an optical data storage device, and the like.

As is apparent from the above, according to the present disclosure, a certain amount of power of a power source is voltage converted and supplied to an external device, and the remaining amount of power of the power source is used to charge a battery of the vehicle, so that heat generation during supply of power to the external device can be reduced and accordingly heat loss can be improved.

In other words, compared to when converting the voltage of power charged in a battery and supplying the converted power to an external device, a heat generation due to the power conversion can be reduced by converting the voltage of a certain amount of power of a power source supplied through a fast charging cable and transferring the converted certain amount of power to an external device.

According to the present disclosure, the amount of heat generation is reduced to thereby prevent a fire or damage to parts due to heat generation during a supply of power to an external device, which can safely supply power to the external device, increase the durability of internal parts, and save electricity bills.

According to the present disclosure, power from an external power source is supplied to an external device through a vehicle to increase the convenience of users using an eco-friendly vehicle, thereby increasing. The sales volume and usage of eco-friendly vehicles with increase of the convenience of eco-friendly vehicles and thus reducing environmental pollution caused by vehicles.

According to the present disclosure, the quality and marketability of an eco-friendly vehicle can be improved, further user satisfaction, vehicle safety, and secure product competitiveness can be improved.

Although embodiments of the present disclosure have been described for illustrative purposes, those skilled in the art will appreciate that various modifications, additions and substitutions are possible, without departing from the scope and spirit of the disclosure. Therefore, embodiments of the present disclosure have not been described for limiting purposes.

What is claimed is:

1. A power distribution apparatus comprising:
a power transmitter to which a power transmission cable for supplying power to an external device is connected;
a fast charger to which a fast charging cable for receiving power from a power source is connected;
a processor configured to, in response to an execution command of a fast charging mode and a load power supply mode, distribute power supplied through the fast charging cable, transfer a portion of the distributed power to the external device, and transfer a remainder of the distributed power to a battery; and
a power converter provided between the fast charger and the power transmitter, and configured to, when transferring the portion of the distributed power to the external device, convert a voltage of the power supplied through the fast charging cable, and transfer the voltage-converted power to the power transmitter.

2. The power distribution apparatus of claim 1, wherein the processor is configured to:
check state of charge (SOC) information of the battery;
determine whether the load power supply mode is performable based on the SOC information and reference SOC information of the battery;
upon determining that the load power supply mode is performable, acquire information about an amount of power to be supplied to the external device and information about an amount of power to be supplied to the battery on the basis of information about a total amount of power of the power source and information about a required amount of power of the external device; and
distribute the power supplied from the power source on the basis of the acquired information about the amount of power to be supplied to the external device and the acquired information about the amount of power to be supplied to the battery.

3. The power distribution apparatus of claim 2, wherein the processor is configured to acquire information about the amount of power to be supplied to the battery on the basis of the information about the total amount of power of the power source and the information about the required amount of power of the external device.

4. The power distribution apparatus of claim 2, wherein the processor is configured to, upon determining that the load power supply mode is not performable, supply all of the power supplied from the power source to the battery.

5. The power distribution apparatus of claim 1, wherein the processor is configured to, in response to execution of the fast charging mode, allow the power supplied through the fast charging cable to be transferred to the battery.

6. The power distribution apparatus of claim 5, wherein the processor is configured to check information about a required charge amount of the battery, and control charge of the battery on the basis of the checked information about the required charge amount of the battery.

7. A vehicle comprising:
a battery;
a power transmitter to which a power transmission cable for supplying power to an external device is connected;
a fast charger to which a fast charging cable for receiving power from a power source is connected;
an inputter configured to receive an input from a user;
a processor configured to, in response to an on-command of a fast charging mode and an on-command of a load power supply mode being received through the inputter, distribute power supplied through the fast charging cable, transfer a portion of the distributed power to the external device, and transfer a remainder of the distributed power to the battery; and
a power converter provided between the fast charger and the power transmitter, and configured to, when transferring the portion of the distributed power to the external device, convert a voltage of the power supplied through the fast charging cable in response to a control command of the processor and transfer the voltage-converted power to the power transmitter.

8. The vehicle of claim 7, further comprising:
a battery management device configured to monitor a state of charge (SOC) of the battery, and output SOC information about the monitored SOC of the battery,
wherein the processor is configured to:
check the SOC information of the battery;
determine whether a charge amount of the battery is greater than or equal to a reference charge amount on the basis of the SOC information of the battery and reference SOC information;
upon determining that the charge amount of the battery is greater than or equal to the reference charge amount, acquire information about an amount of power to be supplied to the external device and an amount of power to be supplied to the battery on the basis of information about a total amount of power of the power source and information about a required amount of the external device; and
distribute the power supplied from the power source on the basis of the acquired information about the amount of power to be supplied to the external device and the amount of power to be supplied to the battery.

9. The vehicle of claim 8, wherein the processor is configured to acquire the information about the amount of power to be supplied to the battery on the basis of the information about the total amount of power of the power source and the information about the required amount of power of the external device.

10. The vehicle of claim 9, wherein the processor is configured to supply power to the external device on the basis of the information about the required amount of power of the external device, determine whether the supply of power to the external device is completed on the basis of the information about the required amount of power of the external device, and upon determining that the supply of power to the external device is completed, supply power to the battery.

11. The vehicle of claim 10, wherein the processor is configured to: after completing supplying power to the external device and upon determining that the supply of power to the battery is not completed on the basis of the information about the amount of power to be supplied to the batter, continue to supply the power to the battery.

12. The vehicle of claim 10, wherein the processor is configured to: after completing supplying power to the external device and upon determining that the supply of power to the battery is completed on the basis of the information about the amount of power to be supplied to the batter, stop supplying the power to the battery.

13. The vehicle of claim 9, wherein the processor is configured to, upon determining that the charge amount of the battery is less than the reference charge amount, supply all of the power supplied from the power source to the battery.

14. The vehicle of claim 9, further comprising a display,
wherein the processor is configured to control the display to display information indicating that the load power supply mode is not performable upon determining that the charge amount of the battery is less than the reference charge amount.

15. The vehicle of claim 7, wherein the processor is configured to, in response to execution of the fast charging mode, allow the power supplied through the fast charging cable to be transferred to the battery.

16. The vehicle of claim 15, wherein the processor is configured to check information about a required charge amount of the battery, and control charge of the battery on the basis of the checked information about the required charge amount of the battery.

17. The vehicle of claim 7, further comprising a slow charger to which a slow charging cable to receive power from the power source is connected,
wherein the processor is configured to, in response to an on-command of a slow charging mode being received through the inputter, control the power converter to convert a voltage of power supplied through the slow charging cable, and
the power converter is configured to convert the voltage of the power supplied through the slow charging cable in response to a control command of the processor, and transfer the converted power to the battery.

18. The vehicle of claim 17, wherein the processor is configured to perform the slow charging mode on the basis of a connection signal of the slow charging cable.
